(19) United States
(12) Patent Application Publication
(10) Pub. No.: US 2010/0058627 A1
(43) Pub. Date: Mar. 11, 2010

(54) Process Of An Organization System

(76) Inventors: Jeremy T. Helmich, Jacksonville, IL (US); Caren S. Helmich, Jacksonville, IL (US)

Correspondence Address: Jeremy Helmich, 528 Hardin Ave., Jacksonville, IL, 62650, US

(21) Appl. No.: 12/205,055

(22) Filed: Sep. 5, 2008

(51) Int. Cl. G09F 1/10

(52) U.S. Cl. 40/124.4

(57) ABSTRACT

A four step process for organization usually in a home type setting. Step 1—Print from a computer program or write on a 3.5″×2″ blank business card. Step 2—Display those cards on a specially designed board to make them very easy to view on a refrigerator or wall. Step 3—Remove the cards from the display board and store them. Step 4—Pull only the cards you wish to re-use from the storage area and put them back on the board again. Example: meals can be printed on the cards and new meals added to the storage tray as they are found to be liked. This prevents having to constantly try to remember meals to plan, just thumb through the cards and choose. This same process could be used for planning kids chores, TV shows to watch, daily to-do list, exercise plan, or anything else that involves planning.

### FIELD OF THE INVENTION

The present invention relates to a process of organization and, more particularly, to a process of organization used for scheduling daily events or reminders on a specially designed computer program and specially designed display board.

### BACKGROUND OF THE INVENTION

Ever since households have been in existence there has been a need for a good way to make sure things get done to make them run smoothly. In today's world this is more noticeable than ever because of the extremely fast paced life that the majority of people seem to live. This is especially true in households with children. Trying to balance work, family life, cleaning the house, cooking meals, getting laundry done, remembering to pick up dry cleaning and school events are just a few of the things that can make family life hectic. After living this kind of fast-paced life for a long time with four kids in our household I began searching for a way to make all of these things more easy to plan, to make them flow together and work together instead of having sporadic chaos when trying to achieve them all. First I started looking on the Internet being sure I would find something there to solve our organization and planning problem, but I did not find anything. Next, I started searching through stores but again found nothing suitable to help. One easy example to use to explain the problem that we encountered is planning meals. We found that we were constantly trying to figure out what to cook each night for dinner after we had both been working all day. We would ask each other, “what do you want to have for dinner?” and of course the answer would be, “I don't know what do you want to have?”. After repeating this a few times in an evening it took up much of our time to figure it out. Another problem that we encountered a lot was having the kids help out with chores that needed to be done without a constant battle to get them to do what they were asked to do. After searching many different avenues I still could find no suitable meal or chore planners that easily addressed the problems. I had in mind a system that would address all of these problems and many more under one system, this is when I started developing what I called the Clip Planner system. I wanted a system that could be totally customizable to our lifestyle and our likes—not someone elses.

As I continued searching for other solutions, I was sure that someone must have something that allowed us to put in our own meals and not only use recipes that someone else had picked out. There is an online service that I found that gives the user a menu for the entire week and gives two optional kid friendly meals. I just didn't want someone else choosing my meals for me and how do they know what my kids like anyway! This service also charges a small monthly fee for this convenience. There is also a fairly popular computer program that contains thousands of recipes that you can plan a weekly meal from by choosing the meals you want and printing them out on your printer. But I wanted something even simpler than having to sit down at the computer and filter through thousands of recipes each week trying to find ones that my family and I would like. As I searched for ways to assign chores for the kids, I could find, it seemed, hundreds of websites and links to chore planners or chore charts as they are popularly called (for some reason) that claimed to have the answer or at least a way to help. But most were designed for little kids with things like “brush your teeth”, “get dressed”, and so forth. What about when the kids get older? Other chore boards can be found at retail stores nationwide but are full of stickers with pre-written chores on them and once again for very little kids. There is a point in a kid's life when brushing their teeth and going potty is no longer a thing that you reward. Other chore boards are dry erase boards that you must constantly erase (which always leaves a film) and re-write every single week—there had to be a better way. Besides that, none of these items addressed all of the problems in one system. I wanted a simplified way to accomplish these tasks that did not require so much planning and effort each and every week.

I did also consider a more structured and high tech approach such as daily planners and PDA's (personal digital assistants). But these created a problem also—they were not very visible to the entire family and once again required a lot of writing or input time. So, I wanted a system that would work without requiring me to write, type or hardly even think when planning weekly chores and meals and it had to be fast—very fast, to accomplish these tasks. Believe it or not, I finally found what I was looking for but it was something I created, and it worked! In two minutes or less, I could plan the weeks meals, the kid's chores and even have a shopping list ready by having the needed ingredients on the back of the card. Before long the kids thought it was a fun system because one of their chores for the week was to set the board up for the next week. Each of them had a chance to pick the other's chores and pick the meals for the week (of course we made adjustments at times). So, we finally had a system that solved our planning problems but as we started using the system we found it to be useful in so many different ways. By creating different category cards at the top of our board we could plan anything we liked. Things like TV shows we didn't want to miss, family fun time, household projects and much more. For certain categories we could quickly hand write a card and stick it on the board and for other more permanent categories, like meals and chores, we printed them on the computer for a neater appearance. One area that I found the planner to be very useful was in my small service business. I would receive calls, write the information down on a card and place it on the board to go do the job on a particular day. The beauty of it was that if I had to reschedule or for some other reason change the day that I needed to do the job, I could simply pull the card from one day and move it to another. When I would go to do the job I could grab the card and take it with me to have all of the pertinent information that I needed. I decided to use standard size business card stock so that users could very easily obtain it at any retail store that carries office supplies so that there are no special gimmicks, gadgets or fees once the system is obtained. By using a system such as this it allows the user to implement the use of a computer to create and store information cards, but the system also allows for a hard copy of the cards to be made and stored, this enables the system to continue working in the event of a non-working or totally disabled or crashed computer. This provides a safety net that provides a peace of mind not available when using electronic storage of information only.

Another area that the system was able to be adapted to was a board to hold a computer printed calendar. I didn't want to buy a store bought calendar every year when I can print one out right from my computer and have all of my personalized information on it (like birthdays and special occasions). But, I found no way to properly display a computer printed calendar. There are many computer programs to create and print calendars but no good way to hang them up conveniently could be found—that is until the Clip Planner system was developed and adapted to a computer printed calendar holder.

Our Clip Planner system has evolved into a functional normal part of our family and if we think about it, we wonder how we ever managed without it. After setting it up, there is no writing, no typing, no dry erasing, no searching for ideas. It's all right at our fingertips.

It is therefore an object of the invention to provide an easy way to design and print cards from a computer program designed specifically for this purpose.

It is another object of the invention to provide a way to display the cards or other items with ease and good functionality.

It is another object of the invention to provide a way of storing these cards in a way to easily access them when needed again.

### SUMMARY OF THE INVENTION

In accordance with the present invention, there is provided a process of an organization system that includes four steps to make planning and re-planning the same or similar events very easy to accomplish. The first step is to use a computer program to design and print or hand write on blank business card sized cards that are 3.5″×2″ in size. After the cards are hand written or printed by using a computer, the cards can continue to step 2.

Step 2 of the process involves displaying the previously mentioned cards on a specially designed board to hold the cards in an easily viewable state. This holding of the cards on the specially designed board can be done via clips, brackets or similar means to allow the cards to be easily placed and removed from the display board. A different style of display board may also be used to display a calendar printed from the computer as well as notes and reminders using the clips, brackets or similar means to hold these items onto the display board.

The 3rd step in the process is to remove and store the cards after they have been used for the desired amount of time on the display board. This involves placing the cards in a small plastic tray or set of drawers to easily hold the cards in an organized way. The 4th and final step in the process is to pull the cards from the storage area and to re-display them on the display board if the user so desires. This prevents the user from having to re-think, re-design and re-write or print the cards all over again. Instead they simply look at their choices and quickly and easily choose from the cards in storage.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a plan view of a clip planner system and how it works;

FIG. 2 is a front view of a basic clip planner card displaying board and its details;

FIG. 3 is a front view of a possible variation of display boards with different card holding options and configurations for holding the cards;

FIG. 4 is a front view of a variation of possible display boards used as a calendar holder and displaying notes; and

FIG. 5 is a front view of a possible variation of a display board used as only a note, order or reminder holder board.

For purposes of clarity and brevity, like elements and components will bear the same designations and numbering throughout the Figures.

### DESCRIPTION OF THE PREFERRED EMBODIMENT

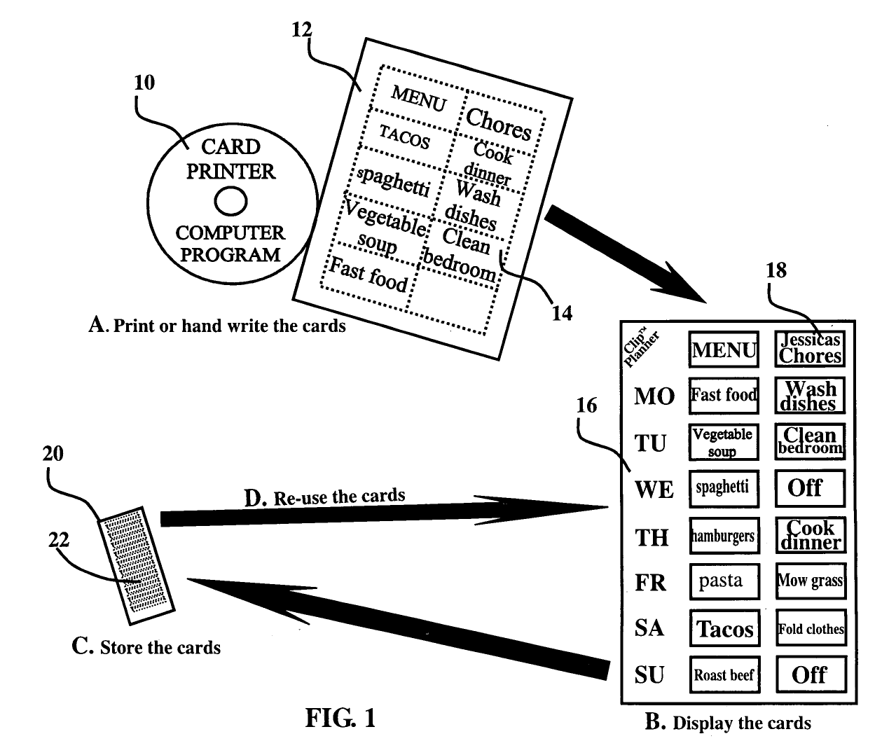

FIG. 1 is a plan view of a process of an organization system and how it works. The Card printer computer program 10 is a custom made program to enable 8.5″×11″ business card stock 12 with individually perforated 3.5″×2″ cards to be printed on. The program gives the ability to input many different categories for the user to accomplish different tasks. A printed category card 18 might be something like: menu, kids chores, jobs to do, inventory, exercise schedule or any other topic that they wish to keep track of, or schedule or be reminded of. After creating a category, a business card size area of 3.5″×2″ is able to be typed on allowing the user to choose color, font, font size, bold and even add symbols or import a picture to be printed on to the card. The current size of business card stock manufactured, such as Avery 5175 business card stock, is available and includes 10 business cards (3.5″×2″ each) with perforations on an 8.5″×11″ area that can be torn apart to have 10 separate cards. A full 10 of these card areas can be viewed from and typed on from a single page of the computer program. Additional pages can be accessed by moving forward to them to create as many pages as are needed for that particular category. Many different categories can be added and a save feature lets the user save to computer memory any work that has been created. Any category can be created or accessed by simply clicking on a box or button on the computer screen by using the computer mouse to go between categories as desired. After the cards have been created satisfactorily, a box that is by each card can be check marked to specify which cards are to be printed. After the 8.5″×11″ business card stock 12 is printed, they can then be torn apart at the perforations and shown as a card after being printed on 14. These same cards, designs or words on the cards, could also be written by hand. The display board 16 can be made of many different materials such as plastic, paper product or even metal. The display board 16 is used to display the previously described card after being printed on 14 through the use of a clip 28 or other holding type device. The display board 16 can be magnetically held to a refrigerator, another metal surface or hung on a convenient wall. When the user is done using or displaying the cards for the desired length of time, they then can then store the cards in the card storage tray 20 until they want to reuse the cards in card storage tray 22 again on the display board 16. The card storage tray 20 may be a simple rectangular plastic box such as a sugar packet holder made by Acco, or the card storage tray 20 may be a series of drawers designed for storing a greater quantity of the cards or it could be some size in between and made of any manufacturable material.

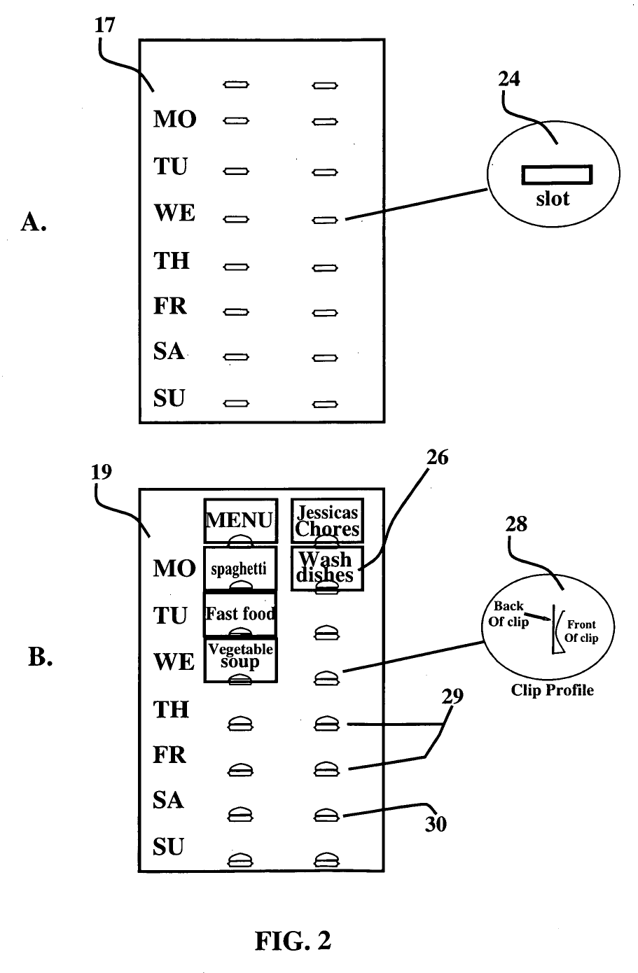

FIG. 2 is a front view of a basic clip 28 planner card displaying board and its details. FIG. 2-A shows a basic display board with slots 17 that are completely through and open to allow the insertion of a clip 28. The back of the clip 28 is inserted into the slot 24 in such a way that the basic display board with slots 17 is between the back and front of the clip 28 causing tension for holding the cards to the basic display board with slots 17, it is then shown as a clip inserted into display board 30. FIG. 2-B shows a basic display board with clips 19 after being inserted into the slots. The clip 28 is approximately the same width as the slot 24 but could be larger or smaller for more or less stability for holding the 1st printed note card 26. The clip 28 may be manufactured of plastic, metal or any other material that is manufacturable to the needed approximate shape. After the clip 28 is inserted into the basic display board with slots 17, a card may then be placed behind it to affix it to the basic display board with clips 19. Each clip 28 is spaced on the basic display board with clips 19 in such a way that the spacing between clips 29 lets the 1st printed note card 26 rest on the bottom of the next higher clip 28 to create a gap at the top of the card between the basic display board with clips 19 and the card that is big enough to be able to grip the top of the card with the fingertips in order to grasp the 1st printed note card 26 to remove it from the basic display board with clips 19.

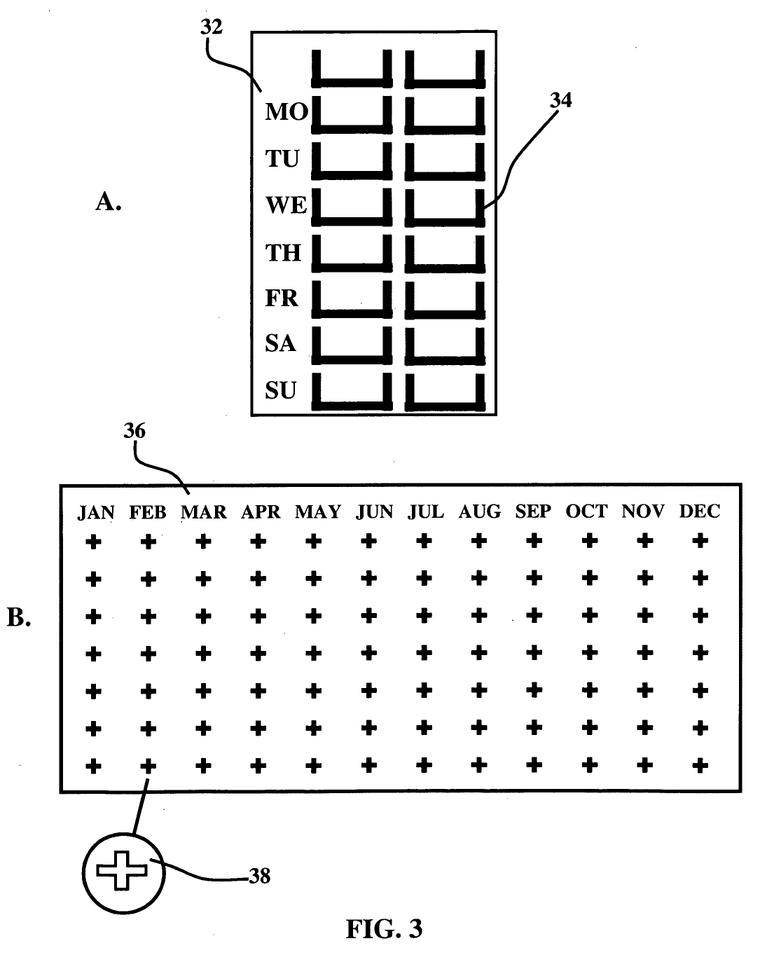

FIG. 3 is a front view of possible variations of a display board 16 with different card holding options and configurations for holding the cards. FIG. 3-A shows the 1st variation of a display board 32 which uses a display holding bracket 34 as a holding device to allow the sides of the cards to be more stable and lined up as opposed to the cards being able to move sideways when using a holding method such as the clip inserted into display board 30. A display holding bracket 34 accomplishes this by having all or part of sides and a bottom to encase the card in a partially enclosed way. A 2nd variation of a display board 36 is shown in FIG. 2-B and shows using the months of the year on a different type of display board 16 that could be used for many different purposes, such as inventories or a variety of different calendar 44 events that could have adjustable days or items because of the movable cards. It is also shown with a multidirectional plus shaped opening slot variation 38 to allow a clip 28 to be inserted in four different directions which would allow a 2nd variation of a display board 36 to be turned in different directions depending on what the user needed it for.

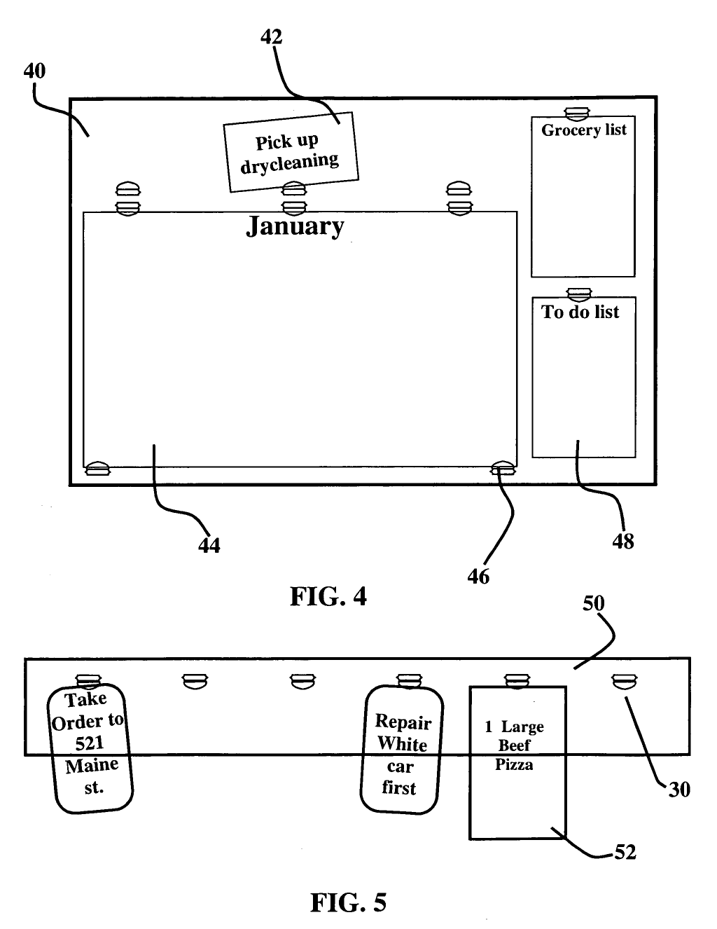

FIG. 4 is a front view of a variation of a possible display board 16 used as a computer printed calendar 44 holder and for displaying notes. FIG. 4 shows another way that the clip 28 system could be used, that is as a computer printed calendar 44 holder and a 2nd printed note card 42 holder board. A computer printed calendar 44 can be slipped behind a clip inserted into display board 30 to hold the computer printed calendar 44 to the 3rd variation of a display board 40 as well as being held by a clip for holding down corner 46 of the computer printed calendar 44 to prevent the bottom corners from curling up. On the right side of the 3rd variation of a display board 40 there is a 3″×5″ card holding area 48 to hold standard note or 3″×5″ file cards that are held by a clip 28. FIG. 5 shows a 4th variation of a display board 50 with a line of clips in a row, this could also be in many other configurations to accommodate the clip 28 system being used as an order board for restaurants, service shops or any other type of message center where notes or orders are kept. The order ticket 52 shown is an example of this usage. This board configuration could also be equipped with the multidirectional slot variation 38 so that the clip inserted into display board 30 could be turned in different directions allowing for different types of uses.

This 4th variation of a display board 50 or any of the display boards in FIGS. 1,2,3 and 4 can also be held up to a surface magnetically or to a wall surface using any form of hanging method.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A process of an organization system for printing, displaying, storing, and re-using cards and organizational items, comprising:
a customized and unique card printer computer program, for providing computer printing capabilities to print, store and create 3.5″×2″ note cards with information on them;
a perforated, white or colored 8.5″×11″ business card stock, for giving the user the option of computer printing and tearing apart the perforated card sections measuring 3.5″×2″ to use them alternately as note cards instead of as business cards, these cards are the right size to print them directly from said card printer computer program;
a thin plastic or paper product display board, having optional magnets on back and slots throughout the board with clips inserted into the slots to hold 3.5″×2″ cards, for providing a way to display the said printed or hand written cards and optionally hanging the display board on a metal surface using magnets or another surface using other hanging means;
a tall enough, high enough, rectangular shape card storage tray, having an opening to hold cards, for giving the user a convenient way to store the computer printed or hand written 3.5″×2″ cards;
a rectangular, open hole completely through the display board as a slot, for giving an opening in said display board to insert the back of the clip into;
a thin plastic or metal, uniquely designed with enough tension clip, for holding one or more cards onto a display board and protruding enough for the next card to rest on the bottom of the clip so that a finger can be allowed to grasp the top of the card because of the clip above it holding the top of the card away from the display board;
a thin plastic or paper product 1st variation of a display board, having bracket holders for cards instead of clips, for displaying printed or hand written cards in a functional way but enclosing some or all of three sides of the card being held onto the display board leaving the top side open to be able to pull out and remove the card from said bracket;
a plastic, metal, or paper display holding bracket, for providing a variational way of holding cards on a display board by means of a bracket enclosing a 3.5″×2″ card on all or part of three sides leaving the top side open to extract said card from bracket;
a thin metal, paper, or plastic, with multi-directional slots 2nd variation of a display board, for displaying printed or hand written cards in a functional way by allowing a clip to be inserted in four different directions to allow the display board to be displayed in different directions depending on the needs of the user;
a thin, metal, plastic, or paper product 3rd variation of a display board, for displaying a computer printed calendar along with note cards using the organizational clip planner system to allow a computer printed calendar and note cards to be displayed on said board in a very functional fashion;
a thin, plastic, or metal clip for holding down corner, for securing the corners of sheet paper such as a computer printed calendar by means of inserting a clip into the said 3rd variation of a display board used in this case for holding down the bottom corners of a computer printed calendar to prevent the corners from curling up;
a rectangular area, with a clip in the top portion 3″×5″ card holding area, for providing a specific area to attach a 3″×5″ card to be used as a list or note area on said 3rd variation of a display board;
a proper measurement for spacing between clips, for so that the top of one 3.5″×2″ card is able to rest on the next higher clip to allow fingertips to grasp it by the gap that is created when the top of the said card is resting on the next higher protruding clip on a display board; and
a plastic, metal or paper product, with clips inserted 4th variation of a display board, for displaying notes, orders, or reminders on a more simple board for a more economical and simplified option of a note or paper holder.
